(19) United States
(12) Patent Application Publication
(10) Pub. No.: US 2016/0344282 A1
(43) Pub. Date: Nov. 24, 2016

(54) POWER FACTOR CORRECTION CONTROL DEVICE FOR DYNAMICALLY SENSING AND BOOST REGULATION

(71) Applicant: INNO-TECH CO., LTD., Taipei City (TW)

(72) Inventors: Shu-Chia Lin, Taipei City (TW); Ching-Yuan Lin, Taipei City (TW); Chih Feng Lin, Taipei City (TW); Wen-Yueh Hsieh, Taipei City (TW)

(21) Appl. No.: 14/830,836

(22) Filed: Aug. 20, 2015

(30) Foreign Application Priority Data
May 21, 2015 (TW) 104116333

(51) Int. Cl. H02M 1/42; H02M 3/335

(52) U.S. Cl. CPC H02M 1/42; H02M 3/33507

(57) ABSTRACT

A power factor correction control device for dynamically sensing and boost regulation includes a rectifying unit, a transformer, a digital regulation controller, a driving element, a sensing resistor, an output diode and an output capacitor. The control device converts an AC input power into a DC output power so as to supply an external load. The transformer includes a primary coil and an auxiliary coil, the controller employs an auxiliary voltage from the auxiliary coil to calculate the current input voltage and the current output voltage to implement feedback control for the driving element. The driving element is thus turned on and off by the controller to achieve boost function such that the output voltage is greater than the input voltage. The present invention obtains the input voltage and the output voltage by calculation without any sensing resistor, thereby reducing power consumption and increasing power conversion efficiency.

### CROSS-REFERENCE TO RELATED APPLICATION

This application claims the priority of Taiwanese patent application No. 104116333, filed on May 21, 2015, which is incorporated herewith by reference.

### BACKGROUND OF THE INVENTION

1. Field of the Invention

The present invention generally relates to a power factor correction control device, and more specifically to a power factor correction control device for dynamically sensing and boost regulation by employing a digital regulation controller to calculate an input voltage and an output voltage based on a turn on auxiliary voltage, a turn off auxiliary voltage and the winding numbers of the auxiliary and primary coils without using any input or output sensing resistor, thereby reducing power consumption and increasing efficiency of power conversion.

2. The Prior Arts

Different electronic devices usually require different electric power for normally preset operations. For instance, integrated circuits (ICs) may need a DC voltage down to 1.2V, electric motors need 12V DC power, and backlight module of LCD monitors need a higher voltage larger than hundreds voltage. Thus, high quality and efficient power converters are needed to meet the requirements of actual applications.

In the prior arts, power factor correction is one of the key topics for power conversion. Owing to the impedance property and variation of the load, a great deal of virtual work not supplied to the load is usually contained in the output power during power conversion such that, efficiency of power conversion is reduced. As a result, the control unit with power factor correction is greatly needed to overcome the above issue.

Furthermore, one illustrative power factor correction control device for boost regulation in the prior arts is shown in FIG. 1, comprising a rectifying unit 10, a transformer 20, a controller CTRL, a driving element Q1, a sensing resistor RS, an output diode Do, an output capacitor Co, a first input sensing resistor Ris1, a second input sensing resistor Ris2, a first output sensing resistor Ros1 and a second output sensing resistor Ros2 for performing a PFC process on a DC output power with an output voltage Vo so as to increase efficiency of power conversion and at the same time, converting an AC input power VAC into the DC output power which is supplied to an external load (not shown) connected in parallel to the output capacitor Co.

The rectifying unit 10 is connected to the AC input power VAC and transforms the AC input power VAC to generate an input voltage Vi.

The transformer 20 comprises a primary coil LP and an auxiliary coil LAUX, each configured to have an opposite polarity to each other. One end of the primary coil LP is connected to the rectifying unit 10 to receive the input voltage Vi, and another end of the primary coil LP is connected to the positive end of the output diode Do. One end of the auxiliary coil LAUX generates an auxiliary coil sensing signal, which is connected to the controller CTRL. Another end of the auxiliary coil LAUX is grounded.

The driving element Q1 has a drain terminal D, a gate terminal G and a source terminal S. The drain terminal D is connected to a connection point of the primary coil LP and the output diode Do, the gate terminal G is connected to the controller CTRL, and the source terminal S is connected to the controller CTRL and one end of the sensing resistor RS. Another end of the sensing resistor RS is grounded. Additionally, an end of the output capacitor Co is connected to the negative end of the output diode Do, and another end of the output capacitor Co is grounded. Thus, the output voltage is generated across the two ends of the output capacitor Co.

The first input sensing resistor Ris1 and the second input sensing resistor Ris2 are connected in series, and the first input sensing resistor Ris1 is coupled to the rectifying unit 10 for receiving the input voltage Vi. An input voltage sensing signal is generated at the connection point of the first input sensing resistor Ris1 and the second input sensing resistor Ris2, and is further transferred to the controller CTRL.

The first output sensing resistor Ros1 and the second output sensing resistor Ros2 are connected in series, and the first output sensing resistor Ros1 is connected to the negative end of the output diode Do for receiving the output voltage Vo. An output voltage sensing signal is generated at the connection point of the first output sensing resistor Ros1 and the second output sensing resistor Ros2, and is further transferred to the controller CTRL.

Specifically, the controller CTRL receives the auxiliary coil sensing signal, the input voltage sensing signal and the output voltage sensing signal to control the gate terminal G of the driving element Q1 to turn on/off, thereby regulating the output voltage Vo and implementing the function of power factor correction.

The controller CTRL generally comprises a zero current protection unit ZCP, a logic control unit LC, a current shaping unit CSN, a multiplier MUL and a differential gain amplifier GM. The specific operation of the controller CTRL comprises: the differential gain amplifier GM amplifying the difference between the output voltage sensing signal and an internal reference voltage VREF to form and transfer a differential gain amplifying signal to the multiplier MUL; the multiplier MUL multiplying the input voltage sensing signal by the differential gain amplifying signal to generate and transfer a mixing signal to the current shaping unit CSN; the zero current protection unit ZCP receiving the auxiliary coil sensing signal to form and transfer a zero current protection signal to the current shaping unit CSN; the current shaping unit CSN receiving the mixing signal, the zero current protection signal and the sensing signal from the source terminal S of the driving element Q1 to perform a current shaping process and thus generate a current shaping signal; and finally, the logic control unit LC generates a logic control signal based on the current shaping signal to control the gate terminal G of the driving element Q1.

However, one of the shortcomings in the prior arts is that the first input sensing resistor Ris1 and the second input sensing resistor Ris2 for sensing the input voltage and the first output sensing resistor Ros1 and the second output sensing resistor Ros2 for sensing the output voltage substantially consume part of input power at actual operation such that efficiency of power conversion is reduced. Therefore, it is greatly needed for a new power factor correction control device, which directly calculates the input voltage and the output voltage without using any input sensing resistor and output sensing resistor and implements the functions of dynamically sensing and boost regulation, thereby overcoming the above problems in the prior arts.

### SUMMARY OF THE INVENTION

The primary objective of the present invention is to provide a power factor correction control device for dynamically sensing and boost regulation, generally comprising a rectifying unit, a transformer, a digital regulation controller, a driving element, a sensing resistor, an output diode and an output capacitor for converting an AC input power into a DC output power supplying an external load so as to achieve regulation function and effectively prevent the DC output power from being affected by the variation of the input power and external load.

Specifically, the rectifying unit is configured to receive and rectify an AC power to generate an input voltage. In general, the rectifying unit can be implemented by a diode bridge or any traditional rectification circuit. The transformer comprises a primary coil and an auxiliary coil, each configured to have an opposite polarity to each other. One end of the primary coil is connected to the rectifying unit, and another end of the primary coil is connected to the positive end of the output diode. One end of the auxiliary coil is connected to an auxiliary terminal of the digital regulation controller, receiving the input voltage from the rectification unit, and another end of the auxiliary coil is grounded.

The driving element is substantially a transistor like a power MOS (metal oxide semiconductor) transistor, having a drain terminal, a gate terminal and a source terminal. The drain terminal is connected to a connection point of the primary coil and the output diode, the gate terminal is connected to a driving control terminal of the digital regulation controller, and the source terminal is connected to an driving sensing terminal of the digital regulation controller and one end of the sensing resistor. Another end of the sensing resistor is grounded. One end of the output capacitor is connected to the negative end of the output diode, and another end of the output capacitor is grounded. In particular, the external load is connected in parallel to the output capacitor.

Furthermore, the digital regulation controller employs an auxiliary voltage from the auxiliary terminal and a sensing voltage from the driving sensing terminal to perform a voltage regulation control process so as to generate a driving signal, which is used to turn on/off the driving element via the driving control terminal. At the same time, the current flowing through the primary coil is controlled by the driving element to increase the voltage of the positive end of the output diode, thereby implementing the boost function. The output voltage at the positive end of the output diode generated through rectification of the output capacitor is thus larger than the input voltage generated by the rectifying unit.

The above voltage regulation control process of the digital regulation controller comprises the following steps.

First, the driving control terminal outputs the driving signal with the high level to turn on the driving element, and at the same time, the digital regulation controller stores the auxiliary voltage of the auxiliary terminal as a turn-on auxiliary voltage expressed by VA1=|VIN|×NA/NP, where VA1 is the turn-on auxiliary voltage, VIN is the input voltage, NA is a winding number of the auxiliary coil, and NP is a winding number of the primary coil. Since the winding number of the primary coil and the winding number of the auxiliary coil are known, the input voltage can be obtained by calculation based on |VIN|=VA1×NP/NA.

Next, the driving control terminal outputs the driving signal with the low level to turn off the driving element, and the digital regulation controller calculates and stores the auxiliary voltage of the auxiliary terminal as a turn-off auxiliary voltage expressed by VA2=|(Vo−VIN)|×NA/NP, where VA2 is the turn-off auxiliary voltage.

A difference value between the turn-on auxiliary voltage and the turn-off auxiliary voltage is then calculated according to VD=Vo×NA/NP, where Vo is the output voltage, and VD is the difference value stored as a difference voltage, which is obviously proportional to the output voltage.

Finally, the output voltage is obtained by calculation based on Vo=VD×NP/NA.

Therefore, the input voltage and the output voltage are obtained by simple calculation without using any input sensing resistor and output sensing resistor so as to decrease power consumption and increase efficiency of power conversion. In particular, the digital regulation controller employs the input voltage and the output voltage to perform a feedback control. For instance, when the driving element is turned off, the difference between the input voltage and the output voltage sensed through the auxiliary coil is specifically fixed to implement the function of boost follow. In other words, the output voltage is kept larger than the input voltage by a fixed value and the power consumption is reduced. If the input voltage is 90-270V, the output voltage is increased up to 200-380V based on the difference voltage like 110V when the driving element is turned off. Thus, the input voltage larger than 270V results in the output voltage fixed at 380V. In comparison with the traditional boost PFC (power factor correction), the present invention greatly reduces power consumption and improves efficiency of power conversion, and the application field is broadened because the relation between the input voltage and the output voltage can be easily and freely controlled by means of digital operation.

### BRIEF DESCRIPTION OF THE DRAWINGS

The present invention can be understood in more detail by reading the subsequent detailed description in conjunction with the examples and references made to the accompanying drawings, wherein:

FIG. 1 is an illustrative view showing the power factor correction control device for boost regulation in the prior arts;

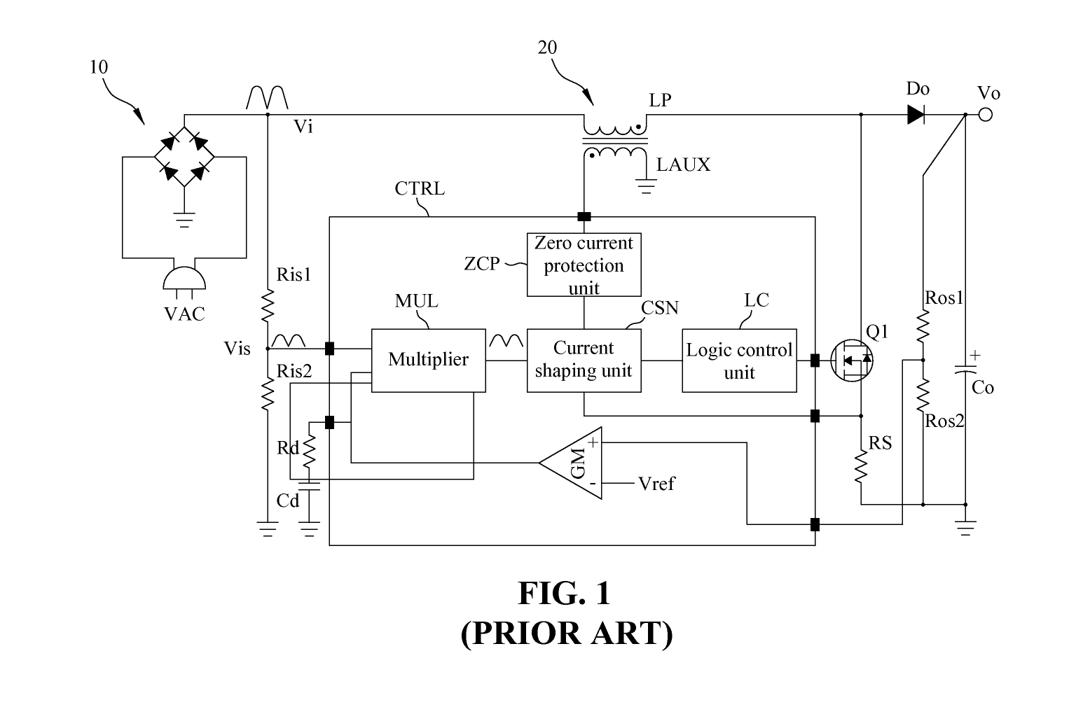

FIG. 2 is a view of the power factor correction control device for dynamically sensing and boost regulation according to one embodiment of the present invention;

FIGS. 3 to 5 are waveform diagrams for the driving signal at different operation modes; and

FIG. 6 is a typical transfer diagram for the power factor correction control device for dynamically sensing and boost regulation according the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

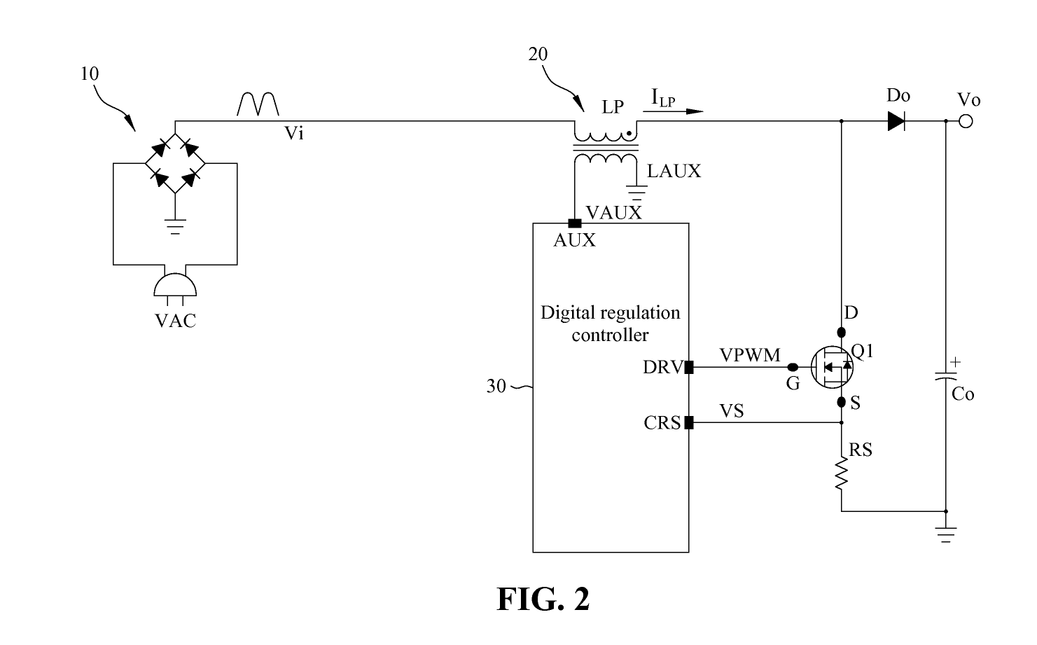

Please refer to FIG. 2 showing the power factor correction (PFC) control device for dynamically sensing and boost regulation according to one embodiment of the present invention. As shown in FIG. 2, the power factor correction control device for dynamically sensing and boost regulation of the present invention generally comprises a rectifying unit 10, a transformer 20, a digital regulation controller 30, a driving element Q1, a sensing resistor RS, an output diode Do and an output capacitor Co for converting an AC input power VAC into a DC output power with an output voltage Vo supplying an external load (not shown), which is connected in parallel to the output capacitor Co.

Specifically, the rectifying unit 10 is connected to the AC input power VAC, and transforms the AC input power VAC into an input voltage Vi. In general, the rectifying unit can be implemented by a rectifying bridge composed of four diodes, or any traditional rectification circuit. The transformer 20 comprises a primary coil LP and an auxiliary coil LAUX, each configured to have an opposite polarity to each other. One end of the primary coil LP is connected to the rectifying unit 10 to receive the input voltage Vi, and another end of the primary coil LP is connected to the positive end of the output diode Do. One end of the auxiliary coil LAUX is connected to an auxiliary terminal AUX of the digital regulation controller 30, and another end of the auxiliary coil LAUX is grounded.

The driving element Q1 is substantially a transistor like a power MOS (metal oxide semiconductor) transistor, and has a drain terminal D, a gate terminal G and a source terminal S.

The drain terminal D is connected to a connection point of the primary coil LP and the output diode Do, the gate terminal G is connected to a driving control terminal DRV of the digital regulation controller 30, and the source terminal S is connected to an driving sensing terminal CRS of the digital regulation controller 30 and one end of the sensing resistor RS. Another end of the sensing resistor RS is grounded. One end of the output capacitor Co is connected to the negative end of the output diode Do, and another end of the output capacitor Co is grounded.

The digital regulation controller 30 is implemented by an electronic device in digital operation, and employs an auxiliary voltage VAUX from the auxiliary terminal AUX and a sensing voltage VS from the driving sensing terminal CRS to perform a voltage regulation control process so as to generate a driving signal VPWM. The driving signal VPWM is output via the driving control terminal DR to control the driving element Q1 to turn on/off. At the same time, the current flowing through the primary coil LP is controlled by the digital regulation controller 30 through the driving element Q1 to increase the voltage of the positive end of the output diode Do, thereby implementing the boost function. Thus, the output voltage Vo at the positive end of the output diode Do generated through rectification of the output capacitor Co is larger than the input voltage Vi generated by the rectifying unit 10.

The digital regulation controller 30 comprises the first analog-to-digital converter (ADC) and the second ADC (not shown). The first ADC is specifically configured for converting the auxiliary voltage VAUX of the auxiliary terminal AUX into a corresponding digital signal, and the second ADC is configured for converting a sensing voltage VS of the driving sensing terminal CRS into a corresponding digital signal such that the digital regulation controller 30 performs digital operation.

More specifically, the driving signal VPWM generated by the digital regulation controller 30 is substantially a PWM (Pulsed Width Modulation) signal. That is, the driving signal VPWM has a high level and a low level with width modulated, which alternate in a fixed duty cycle. Furthermore, the digital regulation controller 30 operates based on a Discontinuous Conduction Mode (DCM), Boundary Conduction Mode (BCM) or Continuous Conduction Mode (CCM) to output the driving signal VPWM with low level via the driving control terminal DRV so as to turn off the driving element Q1, or alternatively, to output the driving signal VPWM with high level to turn on the driving element Q1.

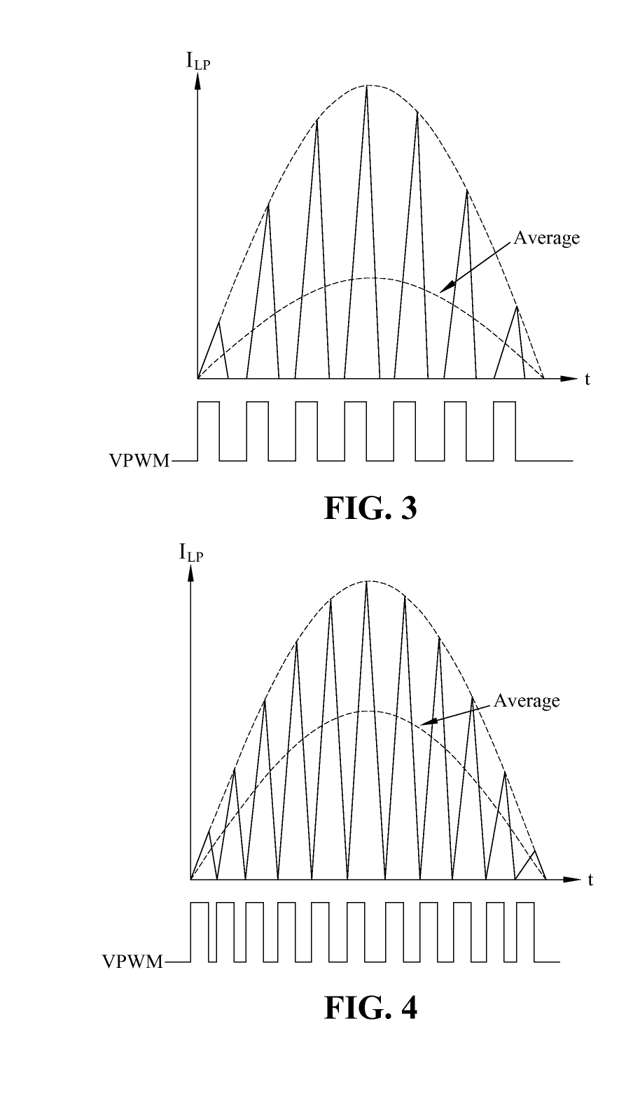

Refer to FIGS. 3, 4 and 5 showing the illustrative waveform diagrams for the driving signal at different operation modes such as DCM, BCM and CCM. The inductor current I_{LP} flows through the primary coil LP.

The above voltage regulation control process of the digital regulation controller 30 specifically comprises the following steps.

First, the driving control terminal DRV outputs the driving signal VPWM with the high level to turn on the driving element Q1. At the same time, the digital regulation controller 30 stores the auxiliary voltage VAUX of the auxiliary terminal AUX as a turn-on auxiliary voltage expressed by VA1=|VIN|×NA/NP, where VA1 is the turn-on auxiliary voltage, NA is a winding number of the auxiliary coil LAUX, and NP is a winding number of the primary coil LP.

Since NP of the primary coil LP and NA of the auxiliary coil LAUX are known, the input voltage Vi can be calculated according to |VIN|=VA1×NP/NA.

Next, the driving control terminal DRV outputs the driving signal VPWM with the low level to turn off the driving element Q1, and the digital regulation controller 30 calculates and stores the auxiliary voltage VAUX of the auxiliary terminal AUX as a turn-off auxiliary voltage expressed by VA2=|(Vo−VIN)|×NA/NP, where VA2 is the turn-off auxiliary voltage.

A difference value between the turn-on auxiliary voltage and the turn-off auxiliary voltage is then calculated according to VD=Vo×NA/NP, where VD is the difference value stored as a difference voltage, which is obviously proportional to the output voltage Vo.

Finally, the output voltage Vo is calculated by the digital regulation controller 30 based on Vo=VD×NP/NA.

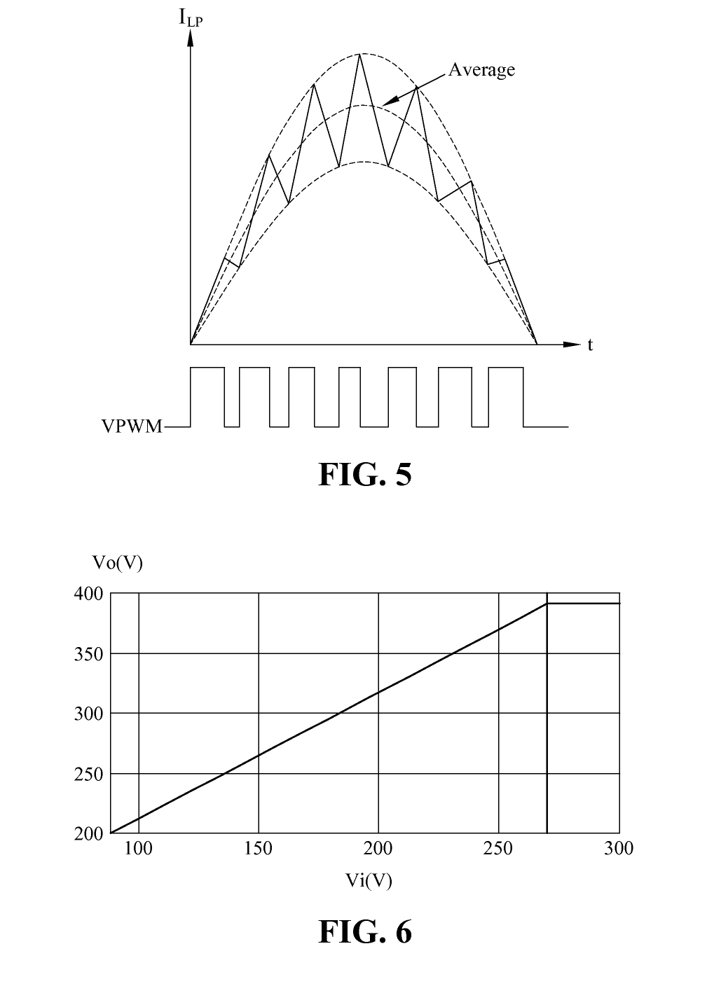

In addition, the digital regulation controller 30 further employs the input voltage Vi and the output voltage Vo calculated to perform the feedback control on the driving element Q1 such that when the driving element Q1 is turned off, the difference between the input voltage Vi and the output voltage Vo sensed through the auxiliary coil LAUX is specifically fixed to implement the function of boost follow. In other words, the output voltage Vo is always kept larger than the input voltage Vi by a fixed value. As shown in FIG. 6, when the input voltage Vi is 90-270V, the output voltage Vo is increased up to 200-380V based on the difference voltage like 110V when the driving element Q1 is turned off Thus, the input voltage Vi larger than 270V results in the output voltage Vo fixed at 380V.

In addition, the auxiliary voltage VAUX from the auxiliary terminal AUX can be obtained by the current flowing through the auxiliary coil LAUX, and a ratio of the current flowing through the auxiliary coil LAUX to the inductor current I_{LP} flowing through the primary coil LP equals a ratio of the winding number of auxiliary coil LAUX to the winding number of primary coil LP, thereby implementing the current feedback control.

From the above mention, one primary feature of the present invention is that in comparison with the traditional boost PFC, the input voltage and the output voltage are obtained by simple calculation without using any input sensing resistor and output sensing resistor so as to decrease power consumption and increase efficiency of power conversion. In particular, the present invention broadens the application field because the relation between the input voltage and the output voltage can be easily and freely controlled by means of digital operation.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power factor correction control device for dynamically sensing and boost regulation and for converting an alternative current (AC) power into a direct current (DC) output power with an output voltage to supply an external load, comprising:
a rectification unit for receiving and rectifying the AC power to generate an input voltage;
a transformer comprising a primary coil and an auxiliary coil, each configured to have an opposite polarity to each other, an end of the primary coil receiving the input voltage from the rectification unit,
a digital regulation controller being a digital electronic element for performing a voltage regulation control process, comprising an auxiliary terminal, a driving sensing terminal and a driving control terminal, the driving sensing terminal outputting a driving signal in a form of pulsed width modulation (PWM), the digital regulation controller generating the driving signal with a low level to turn off the driving element or the driving signal with a high level to turn on the driving element based on one operation mode selected from a discontinuous conduction mode (DCM), a boundary conduction mode (BCM) and a continuous conduction mode (CCM);
a driving element implemented by a transistor having a drain terminal, a gate terminal and a source terminal;
a sensing resistor;
an output diode; and
an output capacitor connected to the external load in parallel,
wherein an another end of the primary coil is connected to a positive end of the output diode, an end of the auxiliary coil is connected to the auxiliary sensing terminal of the digital regulation controller, an another end of the auxiliary sensing terminal is grounded, the drain terminal of the driving element is connected to a connection point of the primary coil and the output diode, the gate terminal of the driving element is connected to the driving control terminal of the digital regulation controller, the source terminal of the driving element is connected to the driving sensing terminal and an end of the sensing resistor, an another end of the sensing resistor is grounded, an end of the output capacitor is connected to a negative end of the output diode, and an another end of the output capacitor is grounded,
wherein the voltage regulation control process of the digital regulation controller comprises steps of:
the driving control terminal outputting the driving signal with the high level to turn on the driving element, the digital regulation controller storing an auxiliary voltage of the auxiliary terminal as a turn-on auxiliary voltage expressed by VA1=|VIN|×NA/NP, VA1 being the turn-on auxiliary voltage, VIN being the input voltage, NA being a winding number of the auxiliary coil, NP being a winding number of the primary coil;
calculating the input voltage based on |VIN|=VA1×NP/NA;
the driving control terminal outputting the driving signal with the low level to turn off the driving element, the digital regulation controller calculating and storing the auxiliary voltage of the auxiliary terminal as a turn-off auxiliary voltage expressed by VA2=|(Vo−VIN)|×NA/NP, VA2 being the turn-off auxiliary voltage;
calculating and storing a difference between the turn-on auxiliary voltage and the turn-off auxiliary voltage as a difference voltage expressed by VD=Vo×NA/NP, VD being the difference voltage, Vo being the output voltage; and
obtaining the output voltage by calculation based on Vo=VD×NP/NA, wherein the digital regulation controller performs a feedback control on the driving element based on the input voltage and the output voltage through calculation so as to implement a boost follow function by fixing the difference voltage between the input voltage and the output voltage sensed by the auxiliary coil as the driving element being turned off, and the output voltage is greater than the input voltage by a fixed value.

2. The power factor correction control device as claimed in claim 1, wherein the rectification unit is implemented by a rectifying bridge comprising four diodes.

3. The power factor correction control device as claimed in claim 1, wherein the driving element is a power MOS (metal oxide semiconductor) transistor.

4. The power factor correction control device as claimed in claim 1, wherein the digital regulation controller comprises a first analog-to-digital converter (ADC) and a second ADC, the first ADC is configured for converting the auxiliary voltage of the auxiliary terminal into a corresponding digital signal, and the second ADC is configured for converting a sensing voltage of the driving sensing terminal into a corresponding digital signal.

5. The power factor correction control device as claimed in claim 1, wherein the auxiliary voltage of the auxiliary terminal is obtained via a current flowing through the auxiliary coil, and a ratio of the current flowing through the auxiliary coil to a current flowing through the primary coil is equal to a ratio of a winding number of the auxiliary coil to a winding number of the primary coil so as to implement a current feedback control.
